(19) United States
(12) Patent Application Publication
(10) Pub. No.: US 2005/0055332 A1
(43) Pub. Date: Mar. 10, 2005

(54) Insertion of symbols in automated documents

(76) Inventor: Philip E. Vasey, Histon (GB)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/933,466

(22) Filed: Sep. 3, 2004

Related U.S. Application Data
(60) Provisional application No. 60/499,380, filed on Sep. 3, 2003.

(51) Int. Cl. G06F 7/00

(52) U.S. Cl. 707/1

(57) ABSTRACT

The present invention provides a document generation system for generating a customised document using content elements selected by rules operating on input information. The customised document further contains symbol elements. The system comprises at least one computer having a document generation program installed thereon, which is capable of generating a fully or a partially customised document by evaluating the rules to select some of the content elements. The system further comprises means to associate further rules with the symbol elements. The rules associated with the symbol elements are evaluated independently of the rules associated with the content elements.

### RELATED US APPLICATIONS

This application claims the benefit of U.S. provisional Application No. 60/499,380, filed 3 Sep. 2003.

### FIELD OF THE INVENTION

The present invention relates to the automated creation of documents, and in particular, to the insertion of such as characters and punctuation elements, for example, the punctuation of conditional clauses within such documents.

### BACKGROUND TO THE INVENTION

It is well known to generate customised documents, either manually or using an automated system, from precedents or templates.

If this is done manually, then a printed standard form or other precedent, containing blank spaces for particular relevant information, will be filled in an edited on each specific occasion it is used. Instructions may be included in the standard document to help the user insert the correct or appropriate information.

If this is done using an automated system, then an electronically stored document or template will be used, in conjunction with various logical rules and other criteria, to prompt the user for the correct information and to assemble a customised document by associating various relevant rules with variables within the template. For example, the HotDocs® system using a library of Form Templates, which store both static and dynamic areas of text, that are initially customised by the user, in conjunction with a questionnaire to produce a completed customised document. Necessary information relevant to the dynamic text areas may either be input directly by a user, or gathered from an Answer File. The Answer File contains information which is repeatedly used in the same or similar customised document. Various logical rules and calculation criteria are used to associate information with the template to produce a final customised document. This document may then be edited, printed or stored.

Other known automated systems include that described in WO01/04772. In this system, a server computer runs a document generation program and is capable of communicating with local or remote client computers over a local area network (LAN) or a wide area network (WAN), such as the internet. A standard document, comprising various items of known information and associated logical rules, is first translated into a form suitable for processing by the document generation program. When instructed to generate a customised document, the server first generates one or more web pages which are sent to client computers for user input of the further information required to evaluate the logical rules. Users may then submit the further information to the server. Once all the required further information has been captured, the server generates a customised document on the basis of the standard document and received further information.

Both of these automated methods produce documents in known word processing formats, such as Microsoft Word. These final documents are static. However, the nature of production of the final document means that there are difficulties in ensuring that the punctuation of series of optional or conditional clauses is correct. For example, if there are six clauses present in a document, the fifth of which is optional, then if this clause is deleted during the production of a document, this leads to difficulties in positioning of commas and the word ‘and’. The mark-up of the template in the case where clauses are optional is illustrated in FIG. 1.

In FIG. 1a, clauses one, four and six are optional, and clauses two, three and five are compulsory. These could relate, for example, to conditions under which services are provided. The optional clauses are marked-up with square brackets [ ]. The last clause generated in the series must end with a full stop. However, this clause may be clause six, if clause six is included, or clause five, if clause six is not included. Similarly, the word ‘and’ must be placed at the end of the penultimate clause. This causes problems as, in this example, any one of clause three (if clauses four and six are not included), clause four (if clause six is not included) or clause five (if clausesix is included, regardless of whether or not clause four is included) may be the penultimate clause. The combinations of possible punctuation is shown in FIG. 1b.

Each of the other clauses must be punctuated using a comma at the end of each clause, as shown in FIG. 1c.

Although there are relatively few clauses in the series, and only three-types of punctuation are needed, the fact that some of the clauses are optional or conditional causes various complications. FIG. 1d shows the added complexity of the mark-up when the conditionality of the punctuation of each clause is considered. At present, the punctuation operation of a document generation program needs to be hand encoded. This is complicated and time consuming, and can swiftly become unfeasible when even only small editing changes are made to the document template.

The main difficulties with hand encoding arise from the fact that the formulation of the punctuation is directly related to the clauses themselves, and therefore requires change whenever the conditions of use change. In particular, the formulation is based on the ordering of the clauses, and therefore must be re-formulated whenever the exact ordering of the clauses changes. For example, the mark-up, and consequently, the coding needed, becomes even more complicated if the order of clauses 4 and 5 is inverted. The punctuation must also be re-formulated when new clauses are added to the system, or when others are removed. Given the difficulties of punctuating fully customised documents, it is virtually impossible to provide accurate punctuation of partially customised document, which still contains conditional text, in the form of clauses or phrases.

There therefore exists a need to provide a method by which a fully or partially customised document, generated by an automated system, can include grammatically correct punctuation of series of optional or conditional clauses, which avoids the need for complex hand encoding and re-editing of the template, and which includes the ability to add, remove and change the ordering of clauses within the series.

There is also a more general need to insert symbols and characters in conditional clauses and text in partially and fully generated documents, whether or not these symbols have a punctuation function.

### SUMMARY OF INVENTION

The present invention provides a document generation system for generating a customised document using content elements selected by rules operating on input information. The customised document further contains symbol elements. The system comprises at least one computer having a document generation program installed thereon, which is capable of generating a fully or a partially customised document by evaluating the rules to select some of the content elements. The system further comprises means to associate further rules with the symbol elements. The rules associated with the symbol elements are evaluated independently of the rules associated with the content elements.

The at least one computer may be part of a client server network, or it may be a stand alone computer, such as a PC. When part of a client server network, it may be either the server computer or a client computer. Communication within the client server network is using known protocols such as TCP/IP, HTTP and XML.

The invention also provides a computer implemented method of generating a customised document, wherein a set of rules, associated with the content elements and a set of rules associated with the symbol elements are evaluated, to enable punctuation of a partially or fully customised generated document. Such a computer implemented method may be implemented as a computer program product and stored on a computer readable medium.

The invention provides the advantages that, regardless of the content elements included within the generated documents, symbols and characters may be inserted into conditional clauses and text in partially and fully generated documents, whether or not these symbols have a punctuation function, and that, if required, the punctuation of series of content elements is always grammatically correct.

### BRIEF DESCRIPTION OF THE DRAWINGS

The invention will now be described by way of example only, and with reference to the accompanying drawings in which:

FIG. 1a referred to above illustrates a first stage of the mark-up of a template in a document generation program illustrating punctuation;

FIG. 1b referred to above illustrates a second stage of the mark-up of a template in a document generation program illustrating hand-encoded punctuation;

FIG. 1c referred to above illustrates a third stage of the mark-up of a template in a document generation program illustrating hand-encoded punctuation;

FIG. 1d referred to above illustrates a fourth stage of the mark-up of a template in a document generation program illustrating hand-encoded punctuation

FIG. 2 illustrates a first network system in which embodiments of the invention may be carried out;

FIG. 3 illustrates a second network system in which embodiments of the invention may be carried out;

FIG. 4 illustrates a third network system in which embodiments of the invention may be carried out;

FIG. 5 is a flow diagram showing the stages in producing a customised document;

FIG. 6 illustrates the mark-up of a template in a document generation program illustrating punctuation when simple editing operations are carried out on the template; and

FIG. 7 illustrates the mark-up of a template in a document generation program showing automated conditional punctuation;

FIG. 8a illustrates pseudo-conditional mark-up;

FIG. 8b illustrates pseudo conditional mark-up;

FIG. 8c illustrates pseudo conditional mark-up;

FIG. 8d illustrates pseudo conditional mark-up;

FIG. 9a illustrates a first mark-up for the punctuation of optional clauses in the template;

FIG. 9b illustrates a second mark-up for the punctuation of optional clauses in the template;

FIG. 9c illustrates the use of a punctuation group in the template;

FIG. 9d illustrates the result on the customised document of removing none of the optional clauses from the template;

FIG. 9e illustrates the result on the customised document of removing all of the optional clauses from the template;

FIG. 10a represents mark-up of repeated information in a template; and

FIGS. 10b, 10c and 10d illustrate the resulting text in the customised document when various numbers of repetitions are used.

### DESCRIPTION OF PREFERRED EMBODIMENTS

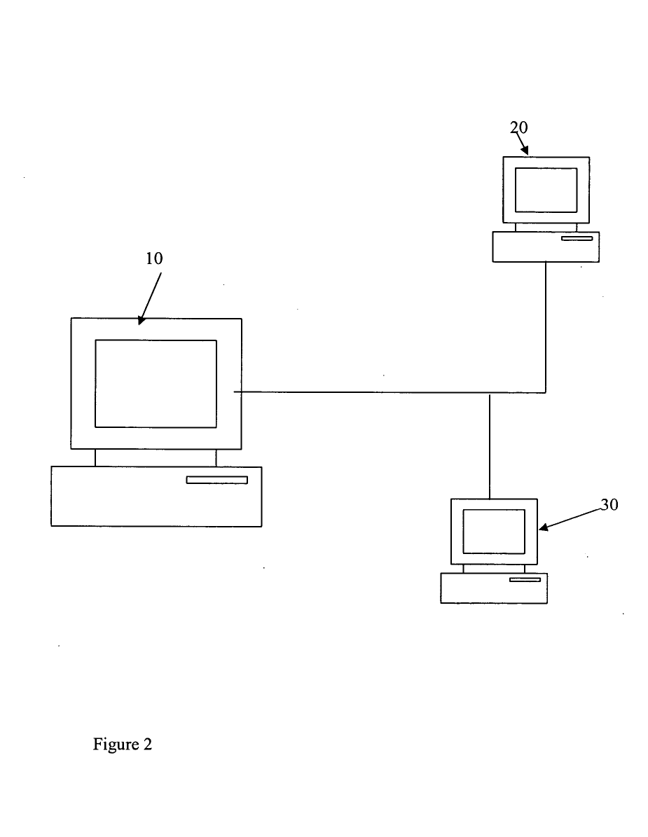

The system in which embodiments of the present invention are implemented will now be briefly described. The system comprises one or more data processing means, which, where a plurality of processing means are used, are connected together using communication means. For example, client/server architecture may be used, with one of the data processing means functioning as a server, and others as clients. However, a single processing means may function as both server and client. Various configurations of client/server architecture are shown in FIGS. 2, 3 and 4.

FIG. 2 shows a server computer 10 connected to two local client computers 20 and 22, connected by means of a local area network (LAN) 30, forming an intranet. Each computer 10, 20, 22, runs an operating system program, such as Microsoft Windows 2000 Professional™ and network programs such as Novell Netware™. The server computer 10 also runs a Web server application such as Microsoft Internet Information Server™, and each of the local client computers 20, 22 also run a browsing application such as Microsoft Internet Explorer™. The server 10 and local computers 20, 22 communicate using transmission control protocol/internet protocol (TCP/IP) and hypertext transfer protocol (HTTP). The invention is not limited to any particular hardware architecture. For example, the invention could be implemented as a stand alone computer such as, for example, a PC.

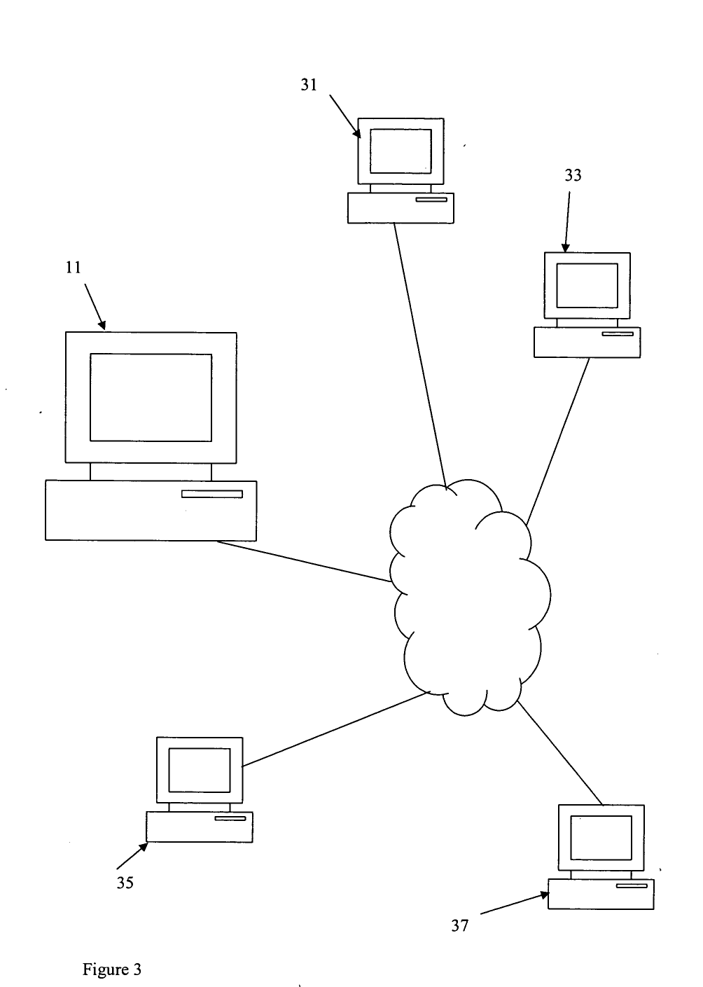

FIG. 3 shows a single server computer 11 connected to four client computers, 31, 33, 35 and 37, using a LAN, each of which runs the operating systems and browser applications mentioned above, and which communicate with the server computer 10 using TCP/IP and HTTP protocols.

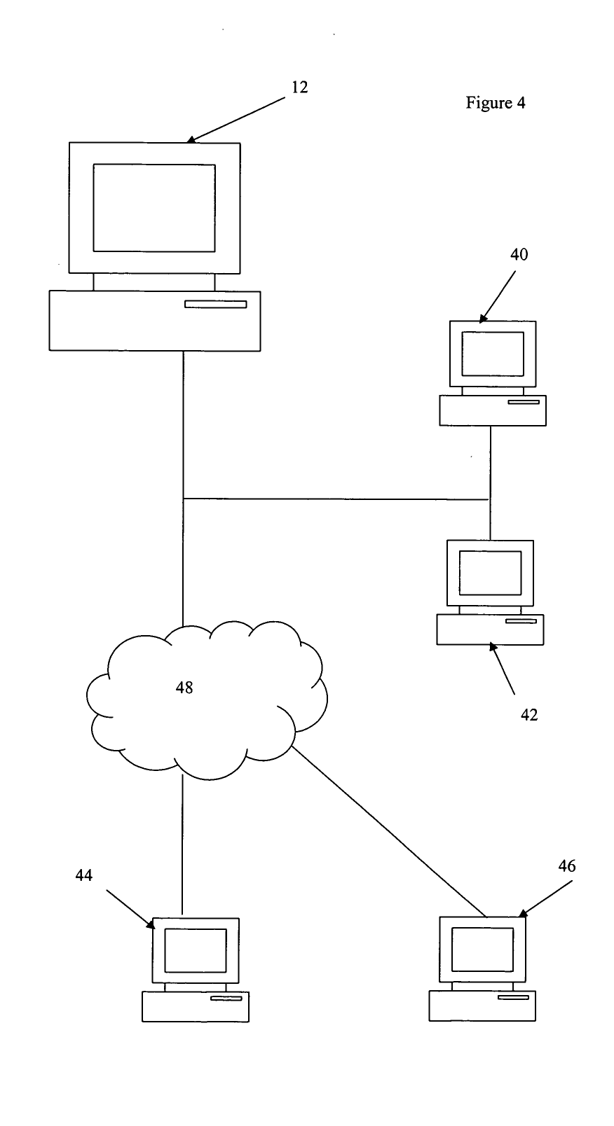

FIG. 4 shows a server computer 12 connected to two local client computers 40 and 42 using a LAN, and also connected to two remote client computers 44 and 46 through the internet 48. Each runs the operating and browser systems and browser systems mentioned above, and proxy servers and firewalls may be used to protect the intranet from unauthorised access from the internet. Again, communication within the intranet is via TCP/IP and HTTP protocols.

As FIG. 4 is the most general arrangement, embodiments of the invention will be described with respect to such a network.

One or more of the computer systems 12, 40, 42, 44 and 46 runs a word processing application such as Microsoft Word™, which is used to create document templates and may be used to view fully or partially customised documents generated by a document generation system. The document template comprises one or more content elements for possible use when generating a customised document and one or more associated rules for determining, on the basis of further information provided by a user, how to use the content elements (which may be conditional clauses or statements) when generating a customised document.

Server computer 12 also runs a document generation program, which, when provided with a template, generates one or more input forms to capture information from a user, the input forms being generated on the basis of rules contained in the template. The document generation program then generates a fully or partially customised documents on the instructions of a user. The document generation program may be run as a server program and is instructed to perform tasks by users of client browser applications.

To generate either a fully or partially customised document from a template, a user instructs the document generation program by sending URL GET or POST request from a client computer, 40, 42, 44 or 46, to the server 12. The document generation program then initiates a session with the client computer. The document generation program may generate one or more Web input forms based on the chosen template, which are passed via a Web server application to the client computer. This Web input form uses standard HTML (hyperlink mark-up language) features such as buttons, free-form entry boxes, tick boxes, pull-down menu list boxes, radio buttons and other graphical user interface (GUI) means for inputting information. The document generation program may generate multiple input forms for distributing to and capturing further information from the users of one or more further client computers 40, 42, 44 46. The document generation program may also produce multiple forms for capturing information from the user of a single client computer in several stages. However, in the following embodiments, it is assumed that only one user of a client computer is involved.

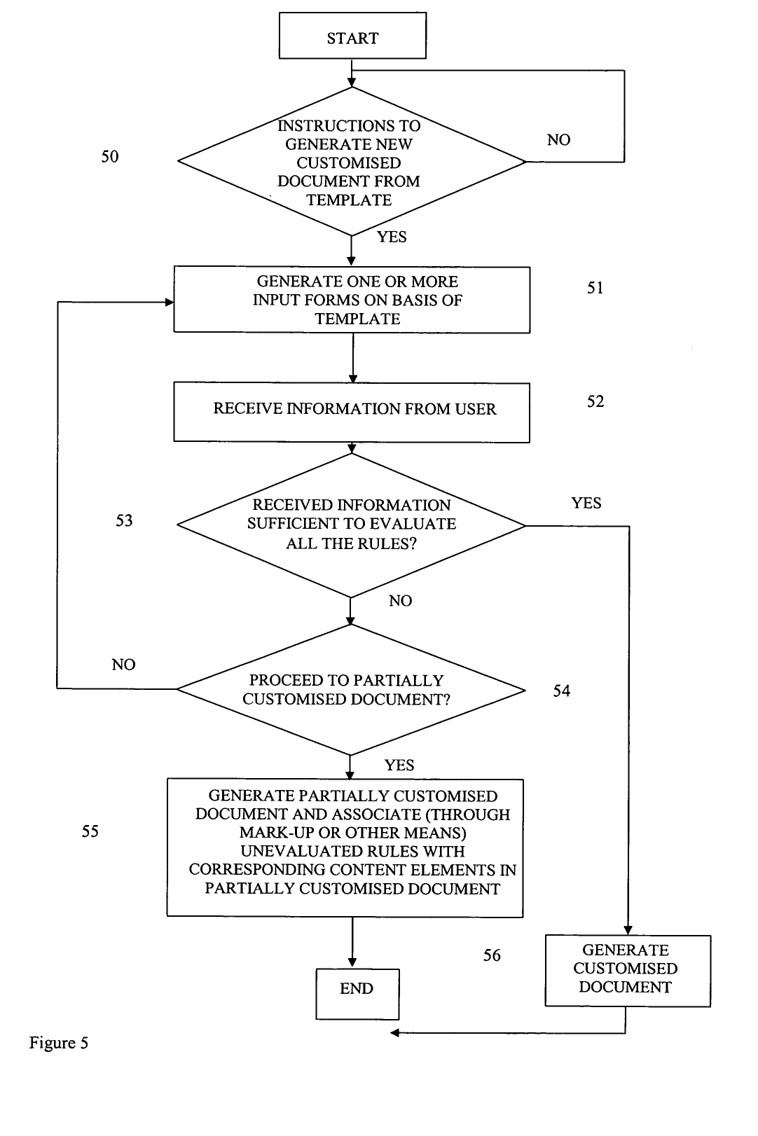

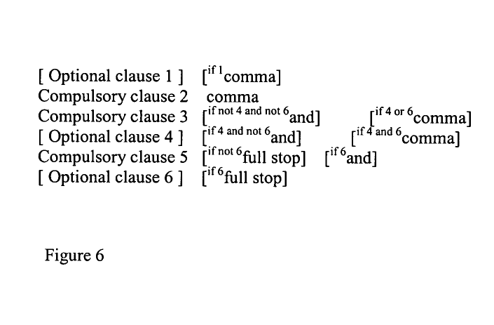

FIG. 5 is a flow diagram showing the process followed by the document generation program. At step 50, the document generation program waits for an instruction from the user to generate a new customised document from a template. On receiving such an instruction, the document generation program generates, at step 51, a first input form on the basis of the rules contained in the template. The user then enters information, using the input form, which is received by the document generation program at step 52. Then, at step 53, the document generation program determines whether the received information is sufficient to evaluate all the rules. If yes, the process continues to step 56 where the document generation program generates a customised document. If no, then the process continues to step 54, where the document generation program determines whether or not it should proceed to generate a partially customised document. If it should, then the process continues to step 55 where such a document is generated. If there is no request from the user to produce a partially customised document (for example, a tick box on the Web input form has been left blank), then the process returns to step 51, and generates further Web input forms for capturing further information from the user. This process is completed until sufficient information is captured to produce either a fully customised document, or a satisfactory partially customised document.

The customised document contains not only the content elements, the inclusion of which has been determined by the various rules within the template, but also the rules which have not been evaluated. The association between the content elements and rules which have not been evaluated may be represented by means of a mark-up.

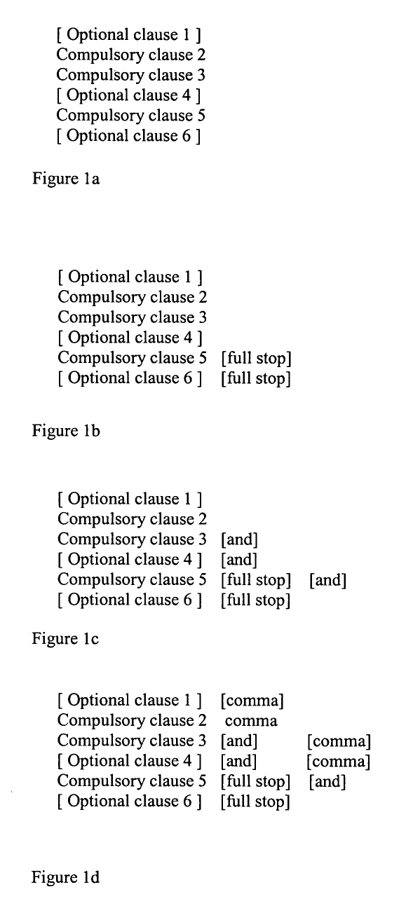

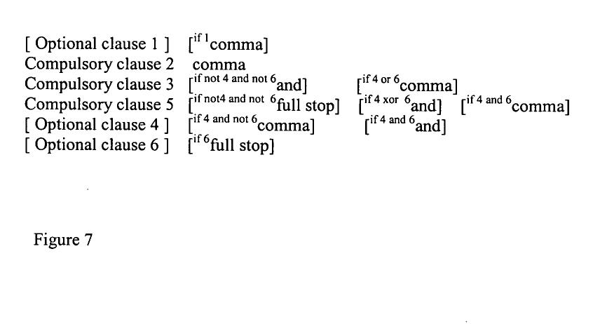

The template from which the document generation program generates the partially or fully customised document also contains information regarding the punctuation of various optional clauses. The punctuation required will be conditional on which clauses are included in or excluded from the customised document. Returning to the example of 6 clauses, given above, where clauses one, four and six are optional, the conditional punctuation is complex, as shown in FIG. 1d. FIG. 7 illustrates the difficulties in performing even simple editing operations on the template. In this case, the order of clauses four and five has been inverted.

Although the representation of the punctuation in the above example is complicated, the conditions which must be satisfied are relatively simple:
1 the last clause in any generated document is terminated with a full stop;
2 the penultimate clause (if one exists) is terminated with and;
3 all other clauses (if any exist) up to the penultimate clause are terminated with a comma.

If this is expressed as part of the mark-up, then the actual order of the clauses becomes irrelevant. Clauses could be re-ordered, deleted and added without needing to change the punctuation, or the associated code.

The mark-up can be used to indicate:
1 the scope of the punctuation, being any contiguous clauses including compulsory and optional clauses;
2 the punctuation symbol which will be inserted after the last clause, if one exists, in any customised document;
3 the punctuation symbol which will be inserted after the penultimate clause, if one exists, in any customised document;
4 the punctuation symbol which will be inserted after all the other clauses, up to, but not including, the penultimate clause in any customised document.

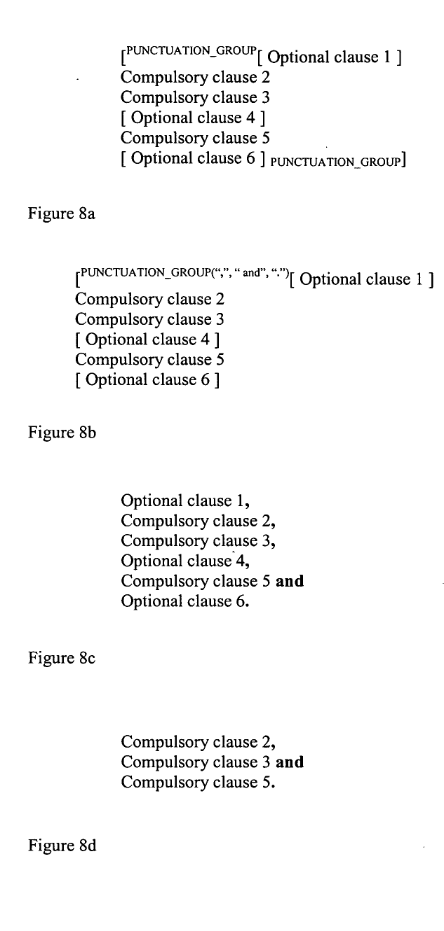

FIGS. 8a and 8b illustrate the use of a pseudo-conditional mark-up to represent the punctuation group which includes all of the relevant clauses. This is tagged PUNCTUATION_GROUP. The punctuation symbols may be marked-up as parameters of the pseudo-conditional, shown as text between ( ) brackets. Text is pseudo-conditional if it occurs within a larger, conditional group, and is itself conditional. FIG. 8c illustrates the form of the text in the customised document when all of the clauses are included. FIG. 8d illustrates the case where none of the optional clauses have been included.

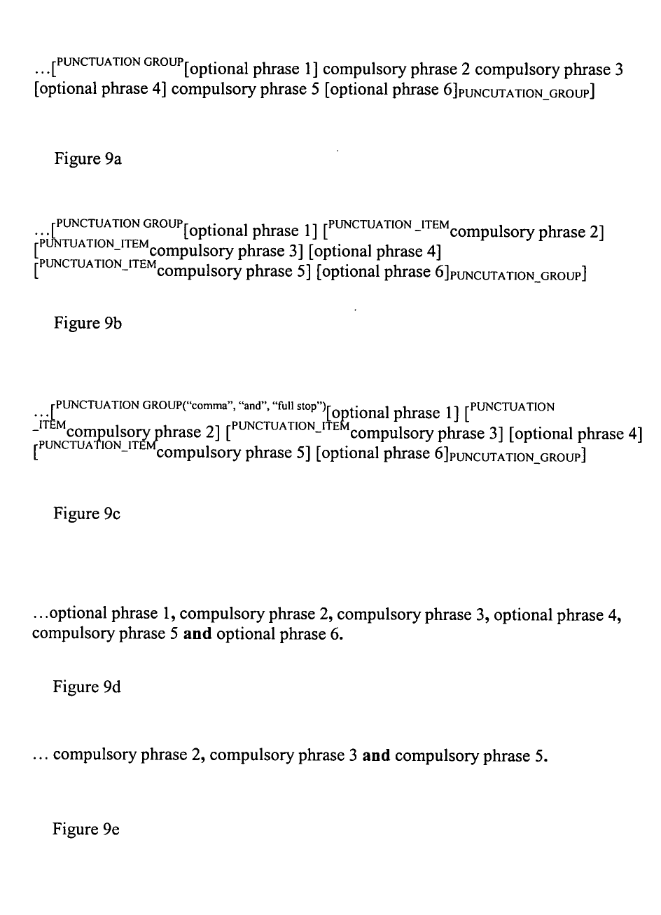

The mark-up can also be extended to included the punctuation of a series of optional and compulsory phrases. This is illustrated in FIGS. 9a to 9e. Similarly to example using conditional clauses above, the mark-up can be used to indicate several features:
1 the scope of the original punctuation, being any contiguous phrases including compulsory and optional phrases within a paragraph;
2 the scope of compulsory (unconditional) phrases;
3 the punctuation symbol which will be inserted after the last phrase, if one exists, in any customised document;
4 the punctuation symbol which will be inserted after the penultimate phrase, if one exists, in any customised document;
5 the punctuation symbol which will be inserted after all the other phrases, up to, but not including, the penultimate phrase in any customised document.

For example, in FIG. 9a, phrases 1, 4 and 6 are optional, whereas phrases 2, 3 and 5 are compulsory. The scope of the punctuation is indicated by enclosing all the phrases within square brackets [ ] and tagging this pseudo-conditional group as a punctuation group. This group is marked PUNCTUATION_GROUP.

In FIG. 9b, the scope of each compulsory phrase is indicated by enclosing each within square brackets [ ] and tagging the pseudo-conditional text as punctuation items, marked PUNCTUATION_ITEM.

In FIG. 9c, the punctuation symbols are marked up as parameters (shown in round ( ) brackets) of the PUNCTUATION_GROUP pseudo-conditional.

FIGS. 9d and 9e illustrate the text which results if all optional phrases are included and if no optional phrases are included, respectively.

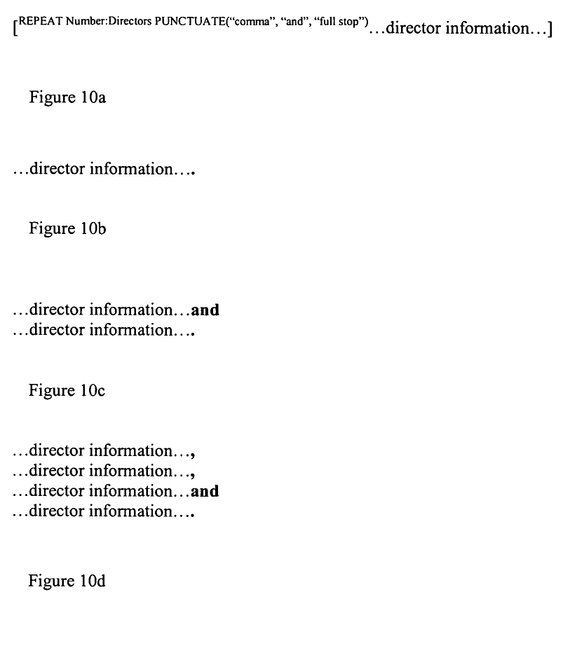

The mark-up can include the nature of various punctuated repetitions. For example, consider a clause or paragraph which includes a list of information, each information item of which is conditional on whether a previous statement has been included in the document. This could be details of company directors, as illustrated in FIGS. 10a to 10d. The amount of information included is dependent on the number of company directors. The mark up may indicate:
the punctuation symbol which will be inserted after the last of a set of repetitions, if one exists, in any customised document;
the punctuation symbol which will be inserted after the penultimate repetition, if one exists, in any customised document;
the punctuation symbol which will be inserted after all the other repetitions, up to, but not including, the penultimate repetition in any customised document.

The mark-up is shown in FIG. 10a. The pseudo-conditional text is tagged REPEAT Number:Directors PUNCTUATE, and the parameters are placed within the round ( ) brackets, “comma”, “and”, “full stop”. If there is one director the document will contain one set of information, as shown in FIG. 10b, if two, the document contains two sets of information, as shown in FIG. 110c and four directors, the document includes four sets of information, as shown in FIG. 10d.

The document generation program must therefore find a way to assign data values to the pseudo-conditional text and parameters to a series of clauses, phrases or repeated statements. These data values must then be evaluated to produce a contiguous series of clauses, phrases or statements. The examples above have covered the generation of fully customised documents. However, it is also necessary to be able to punctuate partially customised documents correctly, and hence the document generation program must be able to cope with some sections of conditional text remaining within the punctuation group.

Embodiments of the present invention overcome this problem by using a punctuation algorithm, which allows the document generation program to assign punctuation data values in both fully and partially customised documents. An example of the punctuation algorithm is given below:
Let X₁, X₂, . . . , Xₖ be the sequence to be punctuated and let P₁, P₂, . . . , P_{K} be their corresponding punctuations.
Let P_{ULTIMATE}, P_{PENULTIMATE} and P_{LEADING} be the ultimate, penultimate and leading punctuation symbols.

Let CF_{ULTIMATE} and CF_{PENULTIMTE} be the carry-forward punctuations.

/* ultimate */

| if | conditional (X_{K}) | |
|---|---|---|
| then | P_{K} | := [P_{ULTIMATE} ] |
| | CF_{ULTIMATE} | := P_{ULTIMATE} |
| else | P_{K} | := P_{ULTIMATE} |
| | CF_{ULTIMATE} | := none |

/* penultimate */

| if | conditional X_{K-1} | | |
|---|---|---|---|
| then | if | CF_{ULTIMATE} = none | |
| | then | P_{K-1} | := [ P_{PENULTIMATE} ] |
| | | CF_{PENULTIMATE} | := P_{PENULTIMATE} |
| | else | P_{K-1} | := [ P_{PENULTIMATE} ] [ P_{ULTIMATE} ] |
| | | CF_{PENULTIMTE} | := P_{PENULTIMTE} |
| else | if | CF_{ULTIMATE} = none | |
| | then | P_{K-1} | := P_{PENULTIMATE} |
| | | CF_{PENULTIMATE} | := none |
| | else | P_{K-1} | := [ P_{PENULTIMATE} ] [ P_{ULTIMATE} ] |
| | | CF_{PENULTIMATE} | := P_{PENULTIMATE} |

CF_{ULTIMATE} = none

/* assign leading punctuations from back to front */
for k = K-2 to 1 step −1

| if | conditional ( Xₖ ) | | |
|---|---|---|---|
| then | if CF_{PENULTIMATE} = none | | |
| | then | Pₖ | := [ P_{LEADING} ] |
| | elif | CF_{ULTIMATE} = none | |
| | then | Pₖ | := [ P_{LEADING} ] [ CF_{PENULTIMATE} ] |
| | else | Pₖ | := [ P_{LEADING} ] [ CF_{PENULTIMATE} ] [ CF_{ULTIMATE} ] |
| else | if | CF_{PENULTIMATE} = none | |
| | then | Pₖ | := P_{LEADING} |
| | elif | CF_{ULTIMATE} = none | |
| | then | Pₖ | := [ P_{LEADING} ] [ CF_{PENULTIMATE} ] |
| | | CF_{PENULTIMATE} = none | |
| | else | Pₖ | := [ P_{LEADING} ] [ CF_{PENULTIMATE} ] [ CF_{ULTIMATE} ] |

CF_{ULTIMATE} = none

end for

The ability to assign punctuation to any form of conditional text from back to front removes some of the difficulties of known systems. For example, it is far easier to insert an ‘and’ between the penultimate clause and the last clause before considering the positions of commas in clauses that occur before the penultimate clause. The algorithm allows the association of simple rules (that a full stop is used at the end of the last clause, that the word ‘and’ follows the penultimate clause, and that commas follow all other clauses, up to but not including the penultimate clause) with any form of conditional text in the template, regardless of any editing which may be done to that text. This is made possible by the separation of the conditional nature of the punctuation from the conditional nature of the clauses and phrases to which the punctuation applies. Unlike in known systems, it is no longer necessary to associate the actual textual content of the phrases with the punctuation.

Although the present invention has been described with respect to the insertion of commas, ‘and’s and full stops, it is also possible to extend the mark-up rules and punctuation algorithm to include the capitalisation of the first word in the first clause or phrase of a series of clauses or phrases. This is particularly useful where the first clause or phrase in a series is optional. Furthermore, any form of punctuation symbol or character, for example, such as colons, semi-colons or brackets; foreign language symbols such as the Greek character a; mathematical or other numerical symbols, such as $ and £ symbols, may also be included in the algorithm, should the generated document require. Symbols and characters from at least one language or different languages may be inserted into a single document. Furthermore, the symbol elements inserted may be grammatically correct and enable the document to be punctuated.

Various modifications symbols and characters from at least one language or different languages may be inserted into a single document to the invention, which are within the scope of the appended claims, will be clear to those skilled in the art.

1-21. (Cancelled).

22. A document generation system for generating a customised document using content elements selected by rules operating on input information, and symbol elements, the system comprising:
at least one computer having a document generation program installed thereon;
wherein the system is capable of generating a fully or a partially customised document by evaluating the rules to select some of the content elements; and
and wherein the system further comprises means to associate further rules with the symbol elements.

23. The document generation system of claim 22, wherein the at least one computer is part of a client server network, comprising at least one client computer and at least one server computer.

24. The document generation system of claim 23, wherein the at least one client computer and the at least one server computer communicate using a communication protocol.

25. The document generation system of claim 24, wherein the communication protocol is at least one of TCP/IP, HTTP or XML.

26. The document generation program of claim 23, wherein the at least one computer is a server computer.

27. The document generation program of claim 23, wherein the at least one computer is a client computer.

28. The document generation system of claim 22, wherein the symbol elements comprise any form of symbol or character.

29. The document generation system of claim 22, wherein the document generation program associates the further rules with the symbol elements.

30. The document generation system of claim 22, wherein the symbol elements comprise characters or punctuation characters.

31. The document generation system of claim 30, wherein the characters or punctuation symbols belong to at least one language.

32. The document generation system of claim 30, wherein characters or punctuation symbols of different languages are inserted into a single document.

33. A document generation system for generating a customised document using content elements selected by rules operating on input information, and symbol elements, the system comprising:
at least one computer having a document generation program installed thereon;
wherein the system is capable of generating a fully or a partially customised document by evaluating the rules to select some of the content elements; and
and wherein the system further comprises means to associate further rules with the symbol elements, the further rules being evaluated independently of the rules for selecting the content elements.

34. A computer-implemented method of document generation using external data and received information, the method comprising:
accessing a template comprising content elements and symbol elements for use when generating a document;
accessing data associated with the template, the data representing at least one rule for making at least one determination of the use of the content elements;
receiving information enabling at least one determination to be made;
associating at least one further rule with the symbol elements;
generating a partially or fully customised document on the basis of the received information; and
evaluating the at least one further rule to enable punctuation of the partially or filly customised document.

35. A computer-implemented method of document generation using external data and received information, the method comprising:
accessing a template comprising content elements and symbol elements for use when generating a document;
accessing data associated with the template, the data representing at least one rule for making at least one determination of the use of the content elements;
receiving information enabling at least one determination to be made;
associating at least one further rule with the symbol elements;
generating a partially or fully customised document on the basis of the received information; and
evaluating the at least one further rule independently of the rules for making at least one determination of the content elements to enable punctuation of the partially or filly customised document.

36. A computer program product comprising a computer readable medium having stored thereon program instructions which when run on a computer causes the computer to perform the steps of:
accessing a template comprising content elements and symbol elements for use when generating a document;
accessing data associated with the template, the data representing at least one rule for making at least one determination of the use of the content elements;
receiving information enabling at least one determination to be made;
associating at least one further rule with the symbol elements;
generating a partially or filly customised document on the basis of the received information; and
evaluating the at least on further rule to enable punctuation of the partially or fully customised document.

37. A computer program product comprising a computer readable medium having stored thereon program instructions which when run on a computer causes the computer to perform the steps of:
accessing a template comprising content elements and symbol elements for use when generating a document;
accessing data associated with the template, the data representing at least one rule for making at least one determination of the use of the content elements;
receiving information enabling at least one determination to be made;
associating at least one further rule with the symbol elements;
generating a partially or fully customised document on the basis of the received information; and
evaluating the at least one further rule independently of the rules for making at least one determination of the content elements to enable punctuation of the partially or fully customised document.

38. A document generation system for generating a customised document using content elements selected by rules operating on input information, and symbol elements, the system comprising:
at least one computer having a document generation program installed thereon;
wherein the system is capable of generating a fully or a partially customised document by evaluating the rules to select some of the content elements; and
and wherein the system further comprises means to associate further rules with the symbol elements, the symbol elements comprising punctuation symbols or characters from at least one language.

39. The document generation system of claim 38, wherein the fully or symbols from at least one language.

40. The document generation system of claim 32, wherein the symbols or punctuation characters are grammatically correct.

41. The document generation system of claim 40 where the punctuation symbols are grammatically correct.

42. A computer-implemented method of document generation using external data and received information, the method comprising:
accessing a template comprising content elements and symbol elements for use when generating a document;
accessing data associated with the template, the data representing at least one rule for making at least one determination of the use of the content elements;
receiving information enabling at least one determination to be made;
associating at least one further rule with the symbol elements;
generating a partially or fully customised document on the basis of the received information; and
evaluating the at least one further rule to enable the insertion of symbols or characters into the partially or fully customised document.

43. A computer-implemented method of document generation using external data and received information, the method comprising:
accessing a template comprising content elements and symbol elements for use when generating a document;
accessing data associated with the template, the data representing at least one rule for making at least one determination of the use of the content elements;
receiving information enabling at least one determination to be made;
associating at least one further rule with the symbol elements;
generating a partially or fully customised document on the basis of the received information; and
evaluating the at least one further rule independently of the rules for making at least one determination of the content elements to enable the insertion of symbols or characters into the partially or fully customised document.

44. A computer program product comprising a computer readable medium having stored thereon program instructions which when run on a computer causes the computer to perform the steps of:
accessing a template comprising content elements and symbol elements for use when generating a document;
accessing data associated with the template, the data representing at least one rule for making at least one determination of the use of the content elements;
receiving information enabling at least one determination to be made;
associating at least one further rule with the symbol elements;
generating a partially or fully customised document on the basis of the received information; and
evaluating the at least on further rule to enable the insertion of symbols or characters into the partially or fully customised document.

45. A computer program product comprising a computer readable medium having stored thereon program instructions which when run on a computer causes the computer to perform the steps of:
accessing a template comprising content elements and symbol elements for use when generating a document;
accessing data associated with the template, the data representing at least one rule for making at least one determination of the use of the content elements;
receiving information enabling at least one determination to be made;
associating at least one further rule with the symbol elements;
generating a partially or fully customised document on the basis of the received information; and
evaluating the at least one further rule independently of the rules for making at least one determination of the content elements to enable the insertion of symbols or characters into the partially or filly customised document.
